(19) United States
(12) Patent Application Publication
(10) Pub. No.: US 2007/0108418 A1
(43) Pub. Date: May 17, 2007

(54) Hair hold formulations

(75) Inventors: David Soane, Chestnut Hill, MA (US); Michael C. Berg, Somerville, MA (US); William A. Mowers, Lynn, MA (US)

Correspondence Address: GOODWIN PROCTER LLP;PATENT ADMINISTRATOR, EXCHANGE PLACE, BOSTON, MA, 02109-2881, US

(73) Assignee: Soane Laboratories, LLC, Cambridge, MA (US)

(21) Appl. No.: 11/501,930

(22) Filed: Aug. 9, 2006

Related U.S. Application Data
(60) Provisional application No. 60/785,432, filed on Mar. 24, 2006.
(60) Provisional application No. 60/706,852, filed on Aug. 9, 2005.
(60) Provisional application No. 60/765,117, filed on Feb. 3, 2006.
(60) Provisional application No. 60/706,853, filed on Aug. 9, 2005.
(60) Provisional application No. 60/708,415, filed on Aug. 15, 2005.

(51) Int. Cl. C09K 15/16

(52) U.S. Cl. 252/405

(57) ABSTRACT

The invention relates to two products, each of which can be designed to provide either permanent or semi-permanent hair hold. A first product includes two formulations applied to the hair in two separate steps, while a second product includes a single formulation applied to the hair in one step.

### PRIOR APPLICATIONS

This application claims benefit of U.S. Provisional Patent Application Nos. 60/785,432, filed Mar. 24, 2006; 60/706,852, filed Aug. 9, 2005; 60/765,117, filed Feb. 3, 2006; 60/706,853, filed Aug. 9, 2005; and 60/708,415, filed Aug. 15, 2005, the texts of which are incorporated herein by reference in their entirety.

### FIELD OF THE INVENTION

This invention relates generally to hair care products. More particularly, in certain embodiments, the invention relates to products for permanent and semi-permanent hair hold.

### BACKGROUND OF THE INVENTION

Conventional hair permanents are effective at maintaining hair hold for a month or longer, but suffer from a notorious odor and leave the hair dry, brittle, and/or tacky. Also, conventional permanents do not offer the option of a “semi-permanent” hair perm which does not last as long as a traditional perm.

Various formulations including polymeric components have been developed to attempt to overcome certain of these problems. Certain relatively new products use emulsions to treat hair, but these products require the use of surfactants or other emulsifying additives to stabilize the emulsion. Such surfactants and other emulsifiers are not active ingredients in the hair hold formulation, and can reduce the effectiveness of the product and/or increase the expense of the product.

### SUMMARY OF THE INVENTION

The invention provides new products for permanent and semi-permanent hair hold. The products provide excellent hold while maintaining hair softness and avoiding a tacky feel. The products may be formulated to be odorless or to have a pleasant fragrance. The products are versatile and may be formulated to provide a desired degree of hair hold permanence.

Both a two-step and a one-step system are provided. In the two-step system, a polycation is applied to the hair in the first step, and a second polymer is applied to the hair in the second step, where the second polymer, for example, a polyanion, forms a complex with the polycation through either electrostatic interactions or covalent bonds. In the one-step formulation, an emulsion is provided in which an aqueous phase polycation surrounds small droplets of a hydrophobic reactive macromer.

In one aspect, the invention relates to a hair hold system including first and second formulations for separate application to hair, the first formulation including a polycation and the second formulation including a polymer capable of either forming a complex with the polycation, forming a covalent bond with the polycation, or both. In a preferred embodiment, advantageous results are obtained when either the polycation of the first formulation or the polymer of the second formulation is a polysaccharide, but not both. In one embodiment, the polymer of the second formulation forms a complex with the polycation upon drying, upon heating, or upon drying and heating of the hair following application of both the first and second formulations to the hair.

In one embodiment, the first formulation is applied to hair in a first step, and the second formulation is applied to the hair in a subsequent step.

In one embodiment, the second formulation includes a polyanion. In one embodiment in which the second formulation includes a polyanion, the polycation is a polysaccharide and the polyanion is not a polysaccharide. In another embodiment in which the second formulation includes a polyanion, the polycation is not a polysaccharide and the polyanion is a polysaccharide. In certain embodiments, the polycation is capable of forming a dimensionally stable layer upon application to hair, and the polyanion is not capable of forming a dimensionally stable layer upon application to hair. In other embodiments, the polyanion is capable of forming a dimensionally stable layer upon application to hair, and the polycation is not capable of forming a dimensionally stable layer upon application to hair.

The polycation and/or the polymer may each have an average molecular weight, for example, of at least about 1000 g/mol, of at least about 10,000 g/mol, at least about 20,000 g/mol, at least about 30,000 g/mol, at least about 40,000 g/mol, at least about 50,000 g/mol, at least about 60,000 g/mol, at least about 70,000 g/mol, at least about 80,000 g/mol, at least about 90,000 g/mol, and/or at least about 100,000 g/mol.

In one embodiment, the polycation includes an amine group, an ammonium group, or both. For example, the polycation may include one or more of the following: poly(dimethyldiallylammonium chloride), polyvinylpyrrolidone, polyethylenimine, polyvinylamine, polyallylamine, chitosan, a cationic cellulose derivative, and/or a cationic starch derivative. In one embodiment, the polycation includes linear polyethyleneimine, which may be substituted, or unsubstituted. In one embodiment, the polycation includes chitosan. The first formulation may include (or be) an aqueous solution.

In one embodiment, the first and/or second formulation include(s) an additive, for example, a cosmetic additive. The additive may include, for example, a UV blocker, a fragrance, a pheromone, a color, a polymeric dye, a conditioner, a thickener, an insect repellent, a preservative, an acid, a base, a salt, a pH adjusting agent, a charge density adjusting agent, a solubility enhancing agent, a deposition aid, and/or a dispersing agent. In one embodiment, the second formulation includes a conditioner. In one embodiment, the additive includes a pH adjusting agent, for example, an agent including an acid, a base, a salt, or any combination thereof. The additive may include a solubility enhancing agent, for example, water, an alcohol, and/or another solvent. The solubility enhancing agent may enhance the solubility of one or more components of the first and/or second formulations. the additive may include a charge density adjusting agent, for example, an agent including an acid, a base, a salt, or any combination thereof.

In one embodiment, the first formulation includes a shampoo. For example, the first formulation may be formulated to allow application of the polycation to hair via shampooing.

In one embodiment, the polymer forms a complex with the polycation upon drying and/or upon heating of the hair following application of the first and second formulations to the hair. In one embodiment, the first and/or the second formulations include a UV blocker, a fragrance, a pheromone, a thickener, an insect repellent, a dispersing agent, and/or a polymeric dye. In one embodiment, the polycation and/or the polymer includes one or more functional groups that provide a fragrance, a color, and/or a UV blocker.

In one embodiment, the polycation includes an amine, and the polymer includes a functional group capable of reacting with the amine, for example, the functional group may include an epoxy, an anhydride, an acid chloride, an ethylenimino, an aldehyde, a hemiacetal, a hemiaminal, a ketone, an alpha-halo ketone, an alpha-hydroxy ketone, a lactone, a thiolactone, an isocyanate, a thiocyanate, an N-hydroxy succinimide ester, an imide, an imine, an imidate, an oxazoline, an oxazolinium, an oxazine, an oxazinium, a pyridyl thio, and/or a thiosulfate group.

In one embodiment, the first formulation has a polycation concentration of 0.01% (w/v) or more, and the second formulation has a polymer concentration of 0.01% (w/v) or more. In one embodiment, the first formulation has a polycation concentration from about 0.01% (w/v) to about 0.5% (w/v), and the second formulation has a polymer concentration from about 0.01% (w/v) to about 0.5% (w/v).

In another aspect, the invention relates to a hair hold system including first and second formulations, the first formulation including a polycation, and the second formulation including a polymer capable of either forming a complex with the polycation, forming a covalent bond with the polycation, or both, wherein the first formulation and the second formulation are kept separate before application to hair. The description of elements of the embodiments above can be applied to this aspect of the invention as well.

In one embodiment, the system includes a container for the first and second formulations having two or more chambers, the chambers separating the first and second formulations. The container may be designed to allow separate application of the first and the second formulations to hair. Alternatively, the container may be designed to allow simultaneous application of the first and second formulations to hair.

In yet another aspect, the invention relates to a hair hold formulation including an emulsion of a hydrophobic macromer in an aqueous solution containing a polycation, where the emulsion is substantially stable for at least one hour at ambient conditions without addition of an emulsifying agent other than the polycation. The description of elements of the embodiments above can be applied to this aspect of the invention as well. In one embodiment, the polycation has an amine, and the hydrophobic macromer has a functional group capable of reacting with the amine. The functional group is at least initially substantially non-reactive with the amine in the formulation, but following application of the formulation to the hair, the functional group reacts with the amine upon drying of the hair, heating of the hair, or both.

In one embodiment, the functional group includes an epoxy, an anhydride, an acid chloride, an ethylenimino, an aldehyde, a hemiacetal, a hemiaminal, a ketone, an alpha-halo ketone, an alpha-hydroxy ketone, a lactone, a thiolactone, an isocyanate, a thiocyanate, an N-hydroxy succinimide ester, an imide, an imine, an imidate, an oxazoline, an oxazolinium, an oxazine, an oxazinium, a pyridyl thio, and/or a thiosulfate group.

The hydrophobic macromer may be capable of hydrostatic interaction with the polycation. For example, the hydrophobic macromer may hydrostatically interacts with the polycation upon drying and/or heating of the emulsion following application of the formulation to hair. The hydrophobic macromer may include a sulfuric acid group, a phosphoric acid group, and/or a carboxylic acid group. The hydrophobic macromer may have a glass transition temperature below about 25° C. and/or it may include a reactive silicone. The reactive silicone may include (or be) an amino-modified silicone, an epoxy-modified silicone, a carboxyl-modified silicone, a carbinol-modified silicone, a methacryl-modified silicone, a phenol-modified silicone, a polyether-modified silicone, and/or a mercapto-modified silicone. The hydrophobic macromer may include an elastomer, for example, polybutadiene and/or polyisoprene. The polybutadiene may include one or more functional groups capable of reaction with the polycation (e.g. reaction with an amine of the polycation).

In one embodiment, the emulsion is substantially stable (e.g. does not phase separate) for at least one month at ambient conditions without addition of an emulsifying agent other than the polycation. In one embodiment, the emulsion is substantially stable (e.g. does not phase separate) for at least one hour at ambient conditions without addition of a surfactant.

In one embodiment, the polycation includes one or more of the following: polyethylenimine, polyvinylamine, polyallylamine, chitosan, a cationic cellulose derivative, and/or a cationic starch derivative. In one embodiment, the polycation includes linear polyethyleneimine, which may be substituted, or unsubstituted. In one embodiment, the polycation includes chitosan.

In one embodiment, the formulation includes an additive, for example, a cosmetic additive. The additive may include, for example, a UV blocker, a fragrance, a pheromone, a color, a polymeric dye, a conditioner, a thickener, an insect repellent, a preservative, an acid, a base, a salt, a pH adjusting agent, a charge density adjusting agent, a solubility enhancing agent, a deposition aid, and/or a dispersing agent. In one embodiment, the second formulation includes a conditioner. In one embodiment, the additive includes a pH adjusting agent, for example, an agent including an acid, a base, a salt, or any combination thereof. The additive may include a solubility enhancing agent, for example, water, an alcohol, and/or another solvent. The solubility enhancing agent may enhance the solubility of one or more components of the first and/or second formulations. The additive may include a charge density adjusting agent, for example, an agent including an acid, a base, a salt, or any combination thereof. The solubility enhancing agent may include a liquid in which the hydrophobic macromer is substantially insoluble. The solubility enhancing agent may enhance the solubility of one or more components of the formulation.

The formulation may include a charge density adjusting agent, including for example, an acid, a base, and/or a salt. The polycation and/or the hydrophobic macromer may include, for example, one or more functional groups providing a fragrance, a color, and/or a UV blocker.

In one embodiment, the formulation has a combined concentration of hydrophobic macromer and polycation of at least about 0.1% (w/v). The combined concentration may be from about 0.1% (w/v) to about 10% (w/v). The formulation may have a weight ratio of polycation to hydrophobic macromer from about 1:1 to about 1:12. This ratio may alternatively be from about 3:1 to about 1:3, from about 2:1 to about 1:2, from about 1.7:1 to 1:1.7, from about 1.5:1 to about 1:1.5, from about 1.4:1 to about 1:1.4, from about 1.3:1 to about 1:1.3, from about 1.2:1 to about 1:1.2, or from about 1.1:1 to about 1:1.1. In certain embodiments, the desired ratio is about 1:1. The formulation may contain, for example, about 0.1% polycation or more, about 0.2% polycation or more, about 0.3% polycation or more, or about 0.4% polycation or more, where the polycation may be chitosan, for example. The polycation may also include, for example, polyethylenimine, polyvinylamine, polyallylamine, chitosan, a cationic cellulose derivative, and/or a cationic starch derivative, where the total amount of polycation is about 0.1% or more, about 0.2% or more, about 0.3% or more, about 0.4% or more, or about 0.5% or more.

### DETAILED DESCRIPTION

In general, embodiments of this invention provide two products, each of which can be formulated to provide either permanent or semi-permanent hair hold. A first product includes two formulations applied to the hair in two separate steps, while a second product includes a single formulation applied to the hair in one step. Either of these products can be formulated to provide hair hold lasting a desired length of time, while still maintaining hair softness and avoiding the tacky feel and unpleasant odor of conventional hair perm products.

It is contemplated that methods, systems, and processes of the claimed invention encompass variations and adaptations developed using information from the embodiments described herein.

Throughout the description, where products, systems, formulations, compositions, mixtures, and blends are described as having, including, or comprising specific components, or where processes and methods are described as having, including, or comprising specific steps, it is contemplated that, additionally, there are products, systems, formulations, compositions, mixtures, and blends of the present invention that consist essentially of, or consist of, the recited components, and that there are processes and methods of the present invention that consist essentially of, or consist of, the recited processing steps.

The mention herein of any publication, for example, in the Background section, is not an admission that the publication serves as prior art with respect to any of the claims presented herein. The Background section is presented for purposes of clarity and is not meant as a description of prior art with respect to any claim.

The two-step system includes a first formulation with a polycation and a second formulation with a polymer, for example, a polyanion. In a preferred embodiment, the first formulation is applied to the hair first, then the second formulation is applied subsequently. While not wishing to be bound to any particular theory, it is believed that the polycation self-assembles onto the hair surface upon application of the first formulation, which causes the hair surface to have a cationic charge. Then, the polyanion of the second formulation is able to self-assemble on the surface of the hair, due to this cationic charge on the hair surface. The polycation and the polyanion form a polymer complex upon drying and/or heating of the hair, and the conformation of the hair is then locked in place. Thus, the two-step system may be considered to follow a polyelectrolyte multilayer approach. This type of two-step system provides a “semi-permanent” hold.

In certain embodiments of the two-step system, the polyanion of the second formulation contains a functional group capable of forming a covalent bond with an amine of the polycation. While not wishing to be bound to any particular theory, it is believed that the polycation self-assembles onto the surface of the hair upon application of the first formulation, leaving free amines (either primary or secondary) that can react with functional groups on the polymer of the second formulation in the second step. These covalent bonds form when the hair is dried and/or slightly heated, to lock in the shape. This type of two-step system provides a substantially permanent hold (as opposed to “semi-permanent” hold via polymer complexation alone).

The one-step system features an emulsion of an aqueous-phase polycation surrounding a hydrophobic macromer. Upon application of the emulsion to hair, the polycation self-assembles onto the hair surface. While not wishing to be bound to any particular theory, it is believed that during drying, the polycation “unwraps” and allows the hydrophobic macromer to form a covalent bond with an amine of the polycation, which locks in the shape. Up until this point, the hydrophobic macromer is maintained substantially non-reactive in the emulsion. The polycation does “double duty” by stabilizing the emulsion prior to application to the hair, and by reacting or otherwise interacting with the hydrophobic macromer following application to the hair.

Where covalent bonds are formed, the one-step system provides a substantially permanent hold (as opposed to “semi-permanent” hold via polymer complexation alone). However, it is possible to formulate a one-step system that provides a “semi-permanent” hold via polymer complexation. For example, a silicone-modified pectin can be used, where the pectin part of the molecule interacts with the polycation, but where the silicone portion provides the “oily” core (i.e. the hydrophobic macromer). Various other one-step systems, including copolymer systems, etc., can be formulated to provide a “semi-permanent” hold via polymer complexation.

In certain embodiments, bonds formed may be considered covalent, ionic, and/or non-covalent. Bonds may also include Van der Walls forces, hydrogen bonds and/or other intermolecular forces.

Polymers comprising amine groups may include primary (—NH₂R), secondary (—NHR₂), and/or tertiary amine (—NR₃) groups. Such polymers may include a quaternary ammonium cation or may be a quaternary ammonium salt. The amine groups may include charged and/or uncharged groups.

Polymers described herein include glycoaminoglycans such as polysaccharides, gums, starch or cationic derivatives thereof, that include an amine group. For example, such polymers may include chitosan, hyaluronic acid, chrondoitin sulfate, and certain proteins or polypeptides. As used herein, “polysaccharide” is understood to mean a biological polymer having sugar subunits, for example, a starch or a cellulose, or a derivative of such a biological polymer, for example, chitosan, pectin, or carboxymethyl cellulose.

Other polymers for use in various embodiments described herein include polyalkyleneamines (PAA) such as tetrabutylenepentamine, polyalkyleneimines (PAI), polyethyleneamine (PEA) such as triethylenetetramine (TETA) and teraethylenepentamine (TEPA), and polyethyleneimines (PEI) such as linear polyethyleneimine (LPEI), branched polyethyleneimine (BPEI), polyallylamines, and polyvinylamines. Branched polyethylenimine, for example, may have at least moderate branching. In certain embodiments, film-forming polymers are used (for “wrapping” of the polymer onto the hair shaft). Still other polymers that can be used in various formulations described herein include such polymers as poly(amido-amine) dendrimers, poly(alkylamino-glucaramide), and linear polymers with a single primary, secondary or tertiary amine group attached to the polymer units, such as poly(dimethylaminoethyl methacrylates), dimethylamino dextran, and polylysines.

As is shown in the Experimental Examples discussed below, it is found that advantageous results for the two-part system are obtained when either the polycation of the first formulation or the polymer of the second formulation is a polysaccharide, but not both. For example, the best combinations of the experiments are chitosan/PAA and LPEI/pectin, while LPEI/PAA did not perform as well. While not wishing to be bound to any particular theory, it is believed that best results are achieved when either the polycation or the polyanion, but not both, is capable of forming a dimensionally-stable layer upon application to hair. A polysaccharide can pack (or crystallize) into a relatively stable layer which remains “lubricated” or fluid when wet, but which firms upon drying.

As used herein, “polysaccharide” is understood to mean a biological polymer having sugar subunits, for example, a starch or a cellulose, or a derivative of such a biological polymer, for example, chitosan, pectin, or carboxymethyl cellulose.

Two-Step Method

In the first step, a polycation is applied to the hair. The polycation can be any natural or synthetic homopolymer or copolymer that contains monomers bearing a cationic charge coming from amine or ammonium functionality. Examples of such polymers include poly(dimethyldiallylammonium chloride), polyvinylpyrrolidone, polyethylenimine (either linear or branched), poly(vinyl amine), poly(allyl amine), chitosan, cationic cellulose derivatives, and cationic starch derivatives. Combinations of these polycations can also be used. The polymer should have high enough molecular weight to form multiple bonds with the hair; therefore, low molecular weight oligomers (MW<1000) are not preferred. It is preferable that the molecular weight be greater than 10,000. A copolymer made by reacting hydrophilic blocks onto the polycation may be desirable to enhance solubility. The polycation can be delivered from an aqueous based solution that may or may not contain other additives commonly used in hair products and/or co-solvents. The solution can be applied to the hair using any standard technique such as working the solution into the hair with a person's hands or spraying the solution onto the hair.

In the second step, a second polymer that interacts with the polycation is applied to the hair. The polymer can be a polyanion that electrostatically binds to the polycation, or the second polymer can contain functional groups that react and form a covalent bond with functional groups on the polycation when dried or heated. The second polymer can also be a copolymer containing such segments. A combination of polymers meeting this description can also be used. The polymer should have high enough molecular weight to form multiple bonds with the hair; thus, low molecular weight oligomers (MW<1000) are not preferred. It is preferable that the molecular weight be greater than 10,000. The polycation can be delivered from an aqueous based solution that may or may not contain other additives commonly used in hair products and/or co-solvents. The solution can be applied to the hair using any standard technique such as working the solution into the hair with a person's hands or spraying the solution onto the hair. After addition of the second polymer, the hair is shaped to the desired style and allowed to dry with or without heat in the desired position.

In the case where a polyanion is used for the second polymer, the hair hold is semi-permanent meaning that if the hair is re-wetted it can be re-shaped and dried to hold in a different style. The polyanions can be any homopolymer or copolymer that has monomers containing acid groups. The acid group can either be a sulfuric acid, phosphoric acid, or carboxylic acid. Examples of such synthetic polymers include polyacrylic acid (PAA), polymethacrylic acid, pectin, carboxymethyl cellulose, and xanthan gum. It is preferred that either the polycation or polyanions can pack or crystallize into a dimensionally stable layer, but only one of the two is chosen from this group. It is surprising that not only does the hair hold shape, but it is soft to the feel. It is believed this softness is achieved because the tacky feel of most polycations is neutralized by the addition of the polyanions.

When the second polymer contains a functionality that reacts with the amine (either primary or secondary) on the polycation, the polymer in the second step forms a covalent bond with the polycation. It is preferable that this polymer has a glass transition temperature below room temperature to give the hair a soft feel. It is also preferable that the reaction not occur until the hair is held in the desired style. Therefore, the reaction should have slow kinetics and/or should not appreciably occur unless heat is added and/or water is removed. Examples of suitable polymers include ones containing the following functional groups: epoxy, anhydride, acid chloride, ethyleneimino, aldehyde, (hemi)acetal, (hemi)aminal, ketone, alpha-halo ketone, alpha-hydroxy ketone, lactone, thio lactone, isocyanate, thiocyanate, N-hydroxy succinimide ester, imide, imine, imidate, oxazoline, oxazolinium, oxazine, oxazinium, pyridyl thio, and thiosulfate. Examples of such polymers include polyisoprene-graft-maleic anhydride, polybutadiene, epoxy/hydroxyl functionalized, poly(dimethylsiloxane) diglycidyl ether terminated, poly[(isobutylene-alt-maleic acid) (ammonium salt)-co-(isobutylene-alt-maleic anhydride)].

The concentrations of the polymer solutions should be above 0.01%. However, the concentrations may be varied depending on the method of application and the other materials in the formulation. Compatible components normally used in cosmetic formulations can be added to the solution (such as fragrances, thickeners, colors, deposition aids, etc.).

One-Step Emulsion Method

The one-step emulsion method presents an aqueous solution of one or more polycations surrounding and stabilizing a core containing a hydrophobic macromer. The polycation can either be a homopolymer or copolymer that has monomers that contain either a primary or secondary amine. Examples of such cationic polymers include polyethylenimine (either linear or branched), poly(vinyl amine), poly(allyl amine), chitosan, cationic cellulose derivatives, and cationic starch derivatives. The hydrophobic macromer should have a functional group that reacts with the amine once the solution is dried and/or heated such as an epoxy, anhydride, acid chloride, ethyleneimino, aldehyde, (hemi)acetal, (hemi)aminal, ketone, alpha-halo ketone, alpha-hydroxy ketone, lactone, thio lactone, isocyanate, thiocyanate, N-hydroxy succinimide ester, imide, imine, imidate, oxazoline, oxazolinium, oxazine, oxazinium, pyridyl thio, and thiosulfate. As an alternative, the hydrophobic macromer can interact with the polycation electrostatically. For instance, the hydrophobic macromer can contain monomers with either a sulfuric acid, phosphoric acid, or carboxylic acid group. The hydrophobic macromer core should not be miscible with water and should have a glass transition temperature below room temperature to provide a soft feel to the hair. Examples of such polymers include reactive silicones and elastomeric polymers such as copolymers containing polyisoprene. The concentration of the hydrophobic component must be low enough that it does not make a continuous phase. The ratio of hydrophobic macromer to polycation can vary depending on the application method. Also, the overall concentration (of hydrophobic macromer and polycation) should be at least 0.1% but can vary depending on the other materials in the formulation. Compatible components normally used in cosmetic formulations can be added to the solution (such as fragrances, thickeners, colors, deposition aids, etc.).

### EXPERIMENTAL EXAMPLES

The chemicals used in the experiments include the following: LPEI: Made in lab through deacylating poly(2-ethyl-2-oxazoline) with acid hydrolosys. (Obtained from Sigma Aldrich #373974 St. Louis, Mo.); Chitosan: Chitoclear CG400 from Primex (Siglufjordur, Iceland); Amidated Pectin: LM-104 AZ from CPKelco (Nijmegen, The Netherlands); Citrus Pectin: Genu Pectin (Citrus) Type USP/100 from CPKelco (Nijmegen, The Netherlands); Low MW CMC: Type 7LXF 2.1%=40 cps from Hercules (Wilmington, Del.); High MW CMC: Cekol 30,000 P from CPKelco (Nijmegen, The Netherlands); Xanthum Gum: XX1110-1 from EMD Chemicals (Gibbstown, N.J.); Polyacrylic acid: 306223 from Sigma Aldrich (St. Louis, Mo.); Polybutadiene (epoxy/hydroxyl functionalized): 387673 from Sigma Aldrich (St. Louis, Mo.); Dow Corning (DC) silicone 8411: 8411 from Dow Corning (Midland, Mich.); GE 9300 and GE 9500 from General Electric (Schenectady, N.Y.); 8-10% (Epoxycyclohexyethyl) methyl-siloxane-dimethylsiloxane: ECMS-924 from Gelest (Morrisville, Pa.); Poly[(isobutylene-alt-maleic acid) (ammonium salt)-co-(isobutylene-alt-maleic anhydride)]: 53 1367 from Sigma Aldrich (St. Louis, Mo.); and Cinnamic acid: C80857 from Sigma Aldrich (St. Louis, Mo.).

Two-Step Treatment

For all examples, clean human hair was treated by first submerging the tuft of hair in the polycation solution for 15 seconds and then rinsing the sample for 10 seconds with water. The hair was next submerged into the second polymer solution (either polyanion or reactive polymer) for 15 seconds followed by a 10 second aqueous rinse. The concentrations of polymer solutions (in both steps) were adjusted to three different concentrations (0.01%, 0.1%, or 0.5% w/v) to study the effect of concentration. It was found that the hair hold results were not significantly affected by changes in the concentration over this range. Therefore, the results reported are for the lowest concentrations (0.01% for both polycation and second polymer treatment). For the polycations, the pH was adjusted to approximately 5.0 to allow the polycation to go into solution. The hair was styled by wrapping it around a 1 cm rod while being dried with a hair dryer. The retention of the curl was measured over time at both 30% and 95% relative humidity (RH) at 20° C. compared to a standard (untreated hair). Subjective notes on the softness of the hair were also taken. In the examples below, the nomenclature refers to the polycation/second polymer.

### Example 0

### Untreated Hair

Hair was submerged in water and then dried by wrapping the hair around a 1 cm rod and dried with a hair dryer. Only a loose curl with a circumference much greater than the 1 cm rod was observed after removing the rod. This curl disappeared quickly even at the lower humidity level. At 95% RH, it lost the curl very quickly.

### Example 1

### Linear Polyethylenimine (LPEI)/Amidated Pectin

At 30% RH, the hair kept a very tight curl for the duration of the test (5 days). At 95% RH, the treatment was far superior to the control but lost most of the curl after 3 days. The hair was also soft to the touch and not tacky.

### Example 2

### Linear Polyethylenimine (LPEI)/Low Methoxy Citrus Pectin

At 30% RH, the hair kept a very tight curl for the duration of the test (5 days). At 95% RH, the treatment was far superior to the control but lost most of the curl after 3 days. The hair was also soft to the touch and not tacky.

### Example 3

### Linear Polyethylenimine (LPEI)/Low Molecular Weight Carboxymethyl Cellulose

At 30% RH, the hair kept a very tight curl for the duration of the test (5 days). At 95% RH, the treatment was far superior to the control but lost most of the curl after 3 days. The hair was also soft to the touch and not tacky.

### Example 4

### Linear Polyethylenimine (LPEI)/High Molecular Weight Carboxymethyl Cellulose

At 30% RH, the hair kept a very tight curl for the duration of the test (5 days). At 95% RH, the treatment was far superior to the control but lost most of the curl after 3 days. The hair was also soft to the touch and not tacky.

### Example 5

### Linear Polyethylenimine (LPEI)/Xanthum Gum

At 30% RH, the hair kept a curl but not as tight as previous examples. At 95% RH, the treatment superior to the control but lost most of the curl after 1 days. The hair was also soft to the touch and not tacky.

### Example 6

### Linear Polyethylenimine (LPEI)/Polyacrylic Acid

At 30% RH, the hair lost its curl quickly but slightly slower than the control. At 95% 20 RH, the hair lost its curl very quickly. The hair was also soft to the touch and not tacky.

### Example 7

### Chitosan/Amidated Pectin

At 30% RH, the hair kept a curl but not as tight as the first four examples. At 95% RH, the treatment superior to the control but lost most of the curl after 1 days. The hair was also soft to the touch and not tacky.

### Example 8

### Chitosan/Low Methoxy Citrus Pectin

At 30% RH, the hair kept a curl but not as tight as the first four examples. At 95% RH, the treatment superior to the control but lost most of the curl after 1 days. The hair was also soft to the touch and not tacky.

### Example 9

### Chitosan/Low Molecular Weight Carboxymethyl Cellulose

At 30% RH, the hair kept a curl but not as tight as the first examples. At 95% RH, the treatment superior to the control but lost most of the curl after 1 days. The hair was also soft to the touch and not tacky.

### Example 10

### Chitosan/High Molecular Weight Carboxymethyl Cellulose

At 30% RH, the hair kept a curl but not as tight as the first four examples. At 95% RH, the treatment superior to the control but lost most of the curl after 1 days. The hair was also soft to the touch and not tacky.

### Example 11

### Chitosan/Xanthum Gum:

At 30% RH, the hair kept a tight curl for the duration of the test (5 days). At 95% RH, the treatment was superior to the control but lost most of the curl after 2 days. The hair was also soft to the touch and not tacky.

### Example 12

### Chitosan/Polyacrylic Acid

At 30% RH, the hair kept a very tight curl for the duration of the test (5 days). At 95% RH, the treatment was far superior to the control but lost most of the curl after 3 days. The hair was also soft to the touch and not tacky.

### Example 13

### LPEI-Co-Polyethylene Glycol/Amidated Pectin

At 30% RH, the hair kept a very tight curl for the duration of the test (5 days). At 95% RH, the treatment was far superior to the control but lost most of the curl after 3 days. The hair was also soft to the touch and not tacky. The cationic copolymer was made reacting LPEI (90%) with polyethylene glycol diglycidyl ether (10%). This copolymer is more soluble in water than LPEI on its own.

### Example 14

### Linear polyethylenimine (LPEI)/poly[(isobutylene-alt-maleic acid) (ammonium salt)-co-(isobutylene-alt-maleic anhydride)]

At 30% RH, the hair kept a very tight curl for the duration of the test (5 days). At 95% RH, the treatment was far superior to the control but lost most of the curl after 3 days. The hair was also soft to the touch and not tacky.

One-Step Treatment

For all examples, clean human hair was treated by submerging the hair in the polymer solution for 10 seconds. The hair was styled by wrapping it around a 1 cm rod while being dried with a hair dryer. The retention of the curl was measured over time at both 30% and 95% relative humidity (RH) at 20° C. compared to a standard (untreated hair). Subjective notes on the softness of the hair were also taken. The ratio of polycation to hydrophobic component was varied as well as the overall concentration.

### Example 15

A 3:1 polybutadiene (epoxy/hydroxyl functionalized): chitosan emulsion was made by homogenizing 3 g of polybutadiene into 100 mL of a 1% aqueous solution of chitosan (pH ˜5). For hair treatments, this solution was used as is (at 4.0%) and diluted with water down to 0.4%. The hair was submerged into each emulsion for 10 seconds and then dried according to the above procedure. The hair held a tight curl in both the 30% and 95% RH conditions for the duration of the test. When the hair was dipped into water, the hair maintained a curl but loosened with the weight of the water. The hair was also soft to the touch and not tacky.

### Example 16

A 3:1 Dow Corning silicone 8411: chitosan emulsion was made by homogenizing 3 g of silicone into 100 mL of a 1% aqueous solution of chitosan (pH˜5). For hair treatments, this solution was used as is (at 4.0%) and diluted with water down to 0.4%. The hair was submerged into each emulsion for 10 seconds and then dried according to the above procedure. The hair held a tight curl in both the 30% and 95% RH conditions for the duration of the test. When the hair was dipped into water, the hair maintained a curl but loosened with the weight of the water. The hair was also soft to the touch and not tacky.

### Example 17

A 3:1 8-10% (Epoxycyclohexyethyl) methyl-siloxane-dimethylsiloxane:chitosan emulsion was made by homogenizing 3 g of siloxane into 100 mL of a 1% aqueous solution of chitosan (pH˜5). For hair treatments, this solution was used as is (at 4.0%) and diluted with water down to 0.4%. The hair was submerged into each emulsion for 10 seconds and then dried according to the above procedure. The hair held a tight curl in both the 30% and 95% RH conditions for the duration of the test. When the hair was dipped into water, the hair maintained a curl but loosened with the weight of the water. The hair was also soft to the touch and not tacky.

### Example 18

A 6:1 polybutadiene (epoxy/hydroxyl functionalized):chitosan emulsion was made by homogenizing 6 g of polybutadiene into 100 mL of a 1% aqueous solution of chitosan (pH ˜5). For hair treatments, this solution was diluted with water down to concentrations of 0.7% and 0.175%. The hair was submerged into each emulsion for 10 seconds and then dried according to the above procedure. The hair held a tight curl in both the 30% and 95% RH conditions for the duration of the test. When the hair was dipped into water, the hair maintained a curl much better than 3:1 ratio in the example above. The hair was also soft to the touch and not tacky.

### Example 19

A 6:1 Dow Corning silicone 8411: chitosan emulsion was made by homogenizing 6 g of silicone into 100 mL of a 1% aqueous solution of chitosan (pH˜5). For hair treatments, this solution was diluted with water down to concentrations of 0.7% and 0.175%. The hair was submerged into each emulsion for 10 seconds and then dried according to the above procedure.

The hair held a tight curl in both the 30% and 95% RH conditions for the duration of the test. When the hair was dipped into water, the hair maintained a curl much better than 3:1 ratio in the example above. The hair was also soft to the touch and not tacky.

### Example 20

A 6:1 8-10% (Epoxycyclohexyethyl) methyl-siloxane-dimethylsiloxane:chitosan emulsion was made by homogenizing 6 g of siloxane into 100 mL of a 1% aqueous solution of chitosan (pH˜5). For hair treatments, this solution was diluted with water down to concentrations of 0.7% and 0.175%. The hair was submerged into each emulsion for 10 seconds and then dried according to the above procedure. The hair held a tight curl in both the 30)% and 95% RH conditions for the duration of the test. When the hair was dipped into water, the hair maintained a curl much better than 3:1 ratio in the example above. The hair was also soft to the touch and not tacky.

### Example with UV-Blocker

### Example 21

A copolymer containing LPEI and cinnamic acid was created by reacting 2 g of LPEI with 0.2 g of cinnamic acid in 75 mL of isopropyl alcohol at 150° C. This copolymer can be substituted for the polycation in any of the above hair styling methods.

### Examples for Immersion Test, Humidity Test, and Drop Test

Immersion Test

The immersion test assesses the hair hold's ability to maintain a curl after immersion in tap water. The procedure consists of two segments, sample preparation and the test itself.

Sample Preparation

1. Wrap a 1.5 cm segment of hair around a serological pipette. Secure the hair with a rubber band at the top and bottom of the curl. Prepare two curls on each pipette, one at the bottom and one at the top.
2. Dip the curl in the hair hold. Rotate the curl in the hair hold to ensure that the entire curl receives an even coat of hair hold.
3. Dry the curls. Typical drying time in a 105° C. oven ranges from 25-40 minutes.
   Immersion Test Procedure
1. Measure the initial length of the curl.
2. Immerse the curl in tap water for 5 seconds.
3. Attach a binder clip to the curl and hang on stand.
4. Measure the final length of the curl after an hour and a half.
   Humidity Test

The humidity test assesses the hair hold's ability to maintain a curl under conditions of up to 95% humidity at room temperature. The procedure for the sample preparation is the same as that used for the immersion test, and the procedure for the experiment is as follows.

Humidity Test Procedure

1. Wet two sponges and place inside the humidity chamber. (The sponges serve as the source of moisture for the experiment.)
2. Measure the initial length of the curl.
3. Record the initial humidity and temperature.
4. Hang curls in the humidity chamber.
5. Leave curls in the humidity chamber for 16-18 hours.
6. Record the final humidity and temperature.
7. Measure the final length of the curls.
   Drop Test

The drop test examines the water resistant properties of each hair hold.

Sample Preparation

1. Weigh each hair sample
2. Lay the hair flat. Apply hair hold equaling one half the mass of the hair sample.
3. Dry the samples. Typical drying time in a 105° C. oven ranges from 20-30 minutes. This hair sample should be straight and rod-like after drying.
   Drop Test Procedure
1. Place a drop of water on each sample.
2. Start timer.
3. Take a picture of all the curls and pictures of smaller groupings of curls, if necessary.
4. Retake pictures at 10, 15, and 30 minutes, or as needed as the drops are absorbed.
5. Record the time at which each drop is absorbed.

The data presented below refers to the formula for HHCR, hair hold curl retention, as the method for judging the effectiveness of the hair hold. This formula is given in Equation 1 as follows:

$$HHCR = \frac{{L}_{max} - {L}_{final}}{{L}_{max} - {L}_{initial}} \qquad ( 1 )$$

where Lₘₐₓ is the straightened length of the hair, L_{final} is the final length of the curl, and Lᵢₙᵢₜᵢₐₗ is the initial length of the curl.

The higher the value of the HHCR, the better the hair hold. The HHCR values are compared relatively to each other to determine which acid, chitosan %, and silicone type and ratio produce the hair hold with the best overall properties.

Example Sets 22-27 are all one-step formulations. For all of Example Sets 22-27, stock chitosan solutions were made by dissolving 20 g of the chitosan (either CG 400 or CG 800) in 1 L of DI water and enough of the acid (acetic or hydrochloric) to dissolve the chitosan to make a 2% stock chitosan solution. From this solution, 25 mL chitosan solutions were obtained at the concentration given in the table by diluting the stock solution with DI water. For example, 12.5 mL of 2% chitosan stock solution plus 12.5 mL of DI water were used to make 25 mL of a 1% chitosan solution. To this 25 mL solution, enough silicone was added to obtain the ratio given in the table and then, the mixture was emulsified with an homogenizer. For example, to make a 1:4 chitosan:silicone sample with 1% chitosan, 1 mL of the silicone was added to the 25 mL 1% chitosan solution sample.

Immersion Test

### Example Set 22

### Acetic Acid, CG 400, 1:4 Chitosan:Silicone

| | Chitosan | Initial length, | Final length, | | HHCR |
|---|---|---|---|---|---|
| Silicone type | % | mm | mm | Lₘₐₓ | in % |
| GE 9300 | 1 | 39 | 45 | 203.2 | 96.35 |
| GE 9300 | 0.5 | 35 | 58 | 203.2 | 86.33 |
| GE 9300 | 0.1 | 58 | 75 | 203.2 | 88.29 |
| GE 9500 | 1 | 36 | 44 | 203.2 | 95.22 |
| GE 9500 | 0.5 | 40 | 50 | 203.2 | 93.87 |
| GE 9500 | 0.1 | 46 | 87 | 203.2 | 73.92 |
| DC 8411 | 1 | 40 | 58 | 203.2 | 88.97 |
| DC 8411 | 0.5 | 44 | 49 | 203.2 | 96.86 |
| DC 8411 | 0.1 | 38 | 95 | 203.2 | 65.50 |
| control | 1 | 36 | 55 | 203.2 | 88.64 |

### Example Set 23

### Acetic Acid, CG 400, 0.3% Chitosan

| | Silicone | original length, | Final length, | | HHCR |
|---|---|---|---|---|---|
| Silicone type | ratio | mm | mm | Lₘₐₓ | in % |
| GE 9300 | 0.5 | 56 | 86 | 203.2 | 79.62 |
| GE 9300 | 1 | 44 | 61 | 203.2 | 89.32 |
| GE 9300 | 2 | 38 | 68 | 203.2 | 81.84 |
| GE 9300 | 4 | 49 | 120 | 203.2 | 53.96 |
| GE 9300 | 8 | 40 | 63 | 203.2 | 85.91 |
| GE 9500 | 0.5 | 35 | 62 | 203.2 | 83.95 |
| GE 9500 | 1 | 36 | 48 | 203.2 | 92.82 |
| GE 9500 | 2 | 43 | 73 | 203.2 | 81.27 |
| GE 9500 | 4 | 50 | 83 | 203.2 | 78.46 |
| GE 9500 | 8 | 45 | 62 | 203.2 | 89.25 |
| DC 8411 | 0.5 | 45 | 64 | 203.2 | 87.99 |
| DC 8411 | 1 | 41 | 55 | 203.2 | 91.37 |
| DC 8411 | 2 | 41 | 55 | 203.2 | 91.37 |
| DC 8411 | 4 | 43 | 64 | 203.2 | 86.89 |
| DC 8411 | 8 | 50 | 120 | 203.2 | 54.31 |

Humidity Test

### Example Set 24

### Hydrochloric Acid, CG 400, 1:4 Chitosan:Silicone

| | Chitosan | Initial length, | Final length, | | HHCR |
|---|---|---|---|---|---|
| Silicone type | % | mm | mm | Lₘₐₓ | in % |
| GE 9300 | 1 | 32 | 33 | 203.2 | 99.42 |
| GE 9300 | 0.5 | 32 | 42 | 203.2 | 94.16 |
| GE 9300 | 0.1 | 42 | 95 | 203.2 | 67.12 |
| GE 9500 | 1 | 30 | 44 | 203.2 | 91.92 |
| GE 9500 | 0.5 | 32 | 42 | 203.2 | 94.16 |
| GE 9500 | 0.1 | 40 | 100 | 203.2 | 63.24 |
| DC 8411 | 1 | 32 | 38 | 203.2 | 96.50 |
| DC 8411 | 0.5 | 32 | 42 | 203.2 | 94.16 |
| DC 8411 | 0.1 | 38 | 98 | 203.2 | 63.68 |
| control | 1 | 39 | 47 | 203.2 | 95.13 |

### Example Set 25

### Acetic Acid, CG 400, 1:4 Chitosan:Silicone

| | Chitosan | Initial length, | Final length, | | HHCR |
|---|---|---|---|---|---|
| Silicone type | % | mm | mm | Lₘₐₓ | in % |
| GE 9300 | 1 | 35 | 38 | 203.2 | 98.22 |
| GE 9300 | 0.5 | 35 | 37 | 203.2 | 98.81 |
| GE 9300 | 0.1 | 44 | 105 | 203.2 | 61.68 |
| GE 9500 | 1 | 31 | 32 | 203.2 | 99.42 |
| GE 9500 | 0.5 | 35 | 46 | 203.2 | 93.46 |
| GE 9500 | 0.1 | 48 | 120 | 203.2 | 53.61 |
| DC 8411 | 1 | 32 | 35 | 203.2 | 98.25 |
| DC 8411 | 0.5 | 36 | 44 | 203.2 | 95.22 |
| DC 8411 | 0.1 | 50 | 114 | 203.2 | 58.22 |
| control | 1 | 34 | 32 | 203.2 | 101.2 |

### Example Set 26

### Acetic Acid, CG 800, 1:4 Chitosan:Silicone

| Silicone | chitosan | original | final length, | Lₘₐₓ, | HHCR |
|---|---|---|---|---|---|
| Type | % | length, mm | mm | mm | in % |
| GE 9300 | 1 | 48 | 82 | 203.2 | 78.09 |
| GE 9300 | 0.5 | 48 | 62 | 203.2 | 90.98 |
| GE 9300 | 0.4 | 58 | 105 | 203.2 | 67.63 |
| GE 9300 | 0.3 | 60 | 120 | 203.2 | 58.10 |
| GE 9300 | 0.2 | 58 | 130 | 203.2 | 50.41 |
| GE 9300 | 0.1 | 65 | 198 | 203.2 | 3.76 |
| GE 9500 | 1 | 48 | 72 | 203.2 | 84.54 |
| GE 9500 | 0.5 | 48 | 95 | 203.2 | 69.72 |
| GE 9500 | 0.4 | 48 | 77 | 203.2 | 81.31 |
| GE 9500 | 0.3 | 57 | 108 | 203.2 | 65.12 |
| GE 9500 | 0.2 | 62 | 128 | 203.2 | 53.26 |
| GE 9500 | 0.1 | 72 | 158 | 203.2 | 34.45 |
| DC 8411 | 1 | 42 | 50 | 203.2 | 95.04 |
| DC 8411 | 0.5 | 44 | 70 | 203.2 | 83.67 |
| DC 8411 | 0.4 | 56 | 100 | 203.2 | 70.11 |
| DC 8411 | 0.3 | 61 | 110 | 203.2 | 65.54 |
| DC 8411 | 0.2 | 62 | 126 | 203.2 | 54.67 |
| DC 8411 | 0.1 | 75 | 170 | 203.2 | 25.90 |

Drop Test

The absorption time represents the length of time that the hair can be exposed to water without absorbing and potentially ruining the curls. There is no specified minimum time for determining a successful hair hold, but 30 minutes was used as an arbitrary goal for absorption time.

### Example Set 27

### Acetic Acid, 1:1 Chitosan:Silicone

| | Silicone | Absorption |
|---|---|---|
| Chitosan % | type | Time, min |
| 1 | none | 23.25 |
| 0.5 | none | 23.25 |
| 0.4 | none | 26.50 |
| 0.3 | none | 14.75 |
| 0.2 | none | 15.00 |
| 0.1 | none | 31.75 |
| 1 | 9300 | 50.25 |
| 0.5 | 9300 | 43.50 |
| 0.4 | 9300 | 43.50 |
| 0.3 | 9300 | 31.25 |
| 0.2 | 9300 | 28.25 |
| 0.1 | 9300 | 33.45 |
| 1 | 9500 | 35.75 |
| 0.5 | 9500 | 51.00 |
| 0.4 | 9500 | 32.00 |
| 0.3 | 9500 | 12.25 |
| 0.2 | 9500 | 12.00 |
| 0.1 | 9500 | 9.50 |
| 1 | 8411 | 62.50 |
| 0.5 | 8411 | 31.00 |
| 0.4 | 8411 | 28.50 |
| 0.3 | 8411 | 28.25 |
| 0.2 | 8411 | 15.00 |
| 0.1 | 8411 | 24.50 |

The most favorable chitosan:silicone ratio seen in the experiments is about 1:1, with properties deteriorating as ratios different from this. In certain embodiments, this ratio may alternatively be from about 3:1 to about 1:3, from about 2:1 to about 1:2, from about 1.7:1 to 1:1.7, from about 1.5:1 to about 1:1.5, from about 1.4:1 to about 1:1.4, from about 1.3:1 to about 1:1.3, from about 1.2:1 to about 1:1.2, or from about 1.1:1 to about 1:1.1.

Also, the minimum effective chitosan concentration in the experiments appears to be about 0.3% (the concentration below which the properties deteriorate).

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A hair hold system comprising first and second formulations for separate application to hair, said first formulation comprising a polycation and said second formulation comprising a polymer capable of at least one of:
(i) forming a complex with said polycation; and
(ii) forming a covalent bond with said polycation.

2. The system of claim 1, wherein said first formulation is applied to hair in a first step and said second formulation is applied to said hair in a subsequent step.

3. The system of claim 1, wherein said second formulation comprises a polyanion.

4. The system of claim 3, wherein said polycation is a polysaccharide and said polyanion is not a polysaccharide.

5. The system of claim 3, wherein said polyanion is a polysaccharide and said polycation is not a polysaccharide.

6. The system of claim 3, wherein said polycation is capable of forming a dimensionally stable layer upon application to hair, and wherein said polyanion is not capable of forming a dimensionally stable layer upon application to hair.

7. The system of claim 3, wherein said polyanion is capable of forming a dimensionally stable layer upon application to hair, and wherein said polycation is not capable of forming a dimensionally stable layer upon application to hair.

8. The system of claim 1, wherein said polycation and said polymer each have an average molecular weight of at least about 1000 g/mol.

9. The system of claim 1, wherein said polycation and said polymer each have an average molecular weight of at least about 50,000 g/mol.

10. The system of claim 1, wherein said polycation comprises an amine group, an ammonium group, or both.

11. The system of claim 1, wherein said polycation comprises at least one member selected from the following: poly(dimethyidiallylammonium chloride), polyvinylpyrrolidone, polyethylenimine, polyvinylamine, polyallylamine, chitosan, a cationic cellulose derivative, and a cationic starch derivative.

12. The system of claim 1, wherein said polycation comprises linear polyethylenimine.

13. The system of claim 1, wherein said linear polyethylenimine is substituted.

14. The system of claim 1, wherein said polycation comprises chitosan.

15. The system of claim 1, wherein said first formulation comprises an aqueous solution.

16. The system of claim 1, wherein at least one of said first formulation and said second formulation comprises an additive.

17. The system of claim 16, wherein said additive is a cosmetic additive.

18. The system of claim 16, wherein said additive comprises at least one member selected from the following: a UV blocker, a fragrance, a pheromone, a color, a polymeric dye, a conditioner, a thickener, an insect repellent, a preservative, an acid, a base, a salt, a pH adjusting agent, a charge density adjusting agent, a solubility enhancing agent, a deposition aid, and a dispersing agent.

19. The system of claim 16, wherein said second formulation comprises said additive, said additive comprising a conditioner.

20. The system of claim 16, wherein said additive comprises a pH adjusting agent, said pH adjusting agent comprising an acid, a base, a salt, or any combination thereof.

21. The system of claim 16, wherein said additive comprises a solubility enhancing agent, said solubility enhancing agent comprising water, an alcohol, another solvent, or any combination thereof.

22. The system of claim 16, wherein said additive comprises a solubility enhancing agent, wherein said solubility enhancing agent enhances the solubility of one or more components of said first formulation, said second formulation, or both.

23. The system of claim 16, wherein said additive comprises a charge density adjusting agent, said charge density adjusting agent comprising an acid, a base, a salt, or any combination thereof.

24. The system of claim 1, wherein said first formulation comprises a shampoo additive.

25. The system of claim 24, wherein said first formulation is formulated to allow application of said polycation to hair via shampooing.

26. The system of claim 1, wherein said polymer forms a complex with said polycation upon drying, upon heating, or upon drying and heating of said hair following application of said first and said second formulations to said hair.

27. The system of claim 1, wherein at least one of said first formulation and said second formulation comprises at least one member selected from the following: a UV blocker, a fragrance, a pheromone, a thickener, an insect repellent, a dispersing agent, and a polymeric dye.

28. The system of claim 1, wherein at least one of said polycation and said polymer comprises at least one functional group providing at least one of the following: a fragrance, a color, and a UV blocker.

29. The system of claim 1, wherein said polycation comprises an amine and wherein said polymer comprises a functional group capable of reacting with said amine.

30. The system of claim 29, wherein said functional group comprises at least one member selected from the following: an epoxy, an anhydride, an acid chloride, an ethylenimino, an aldehyde, a hemiacetal, a hemiaminal, a ketone, an alpha-halo ketone, an alpha-hydroxy ketone, a lactone, a thiolactone, an isocyanate, a thiocyanate, an N-hydroxy succinimide ester, an imide, an imine, an imidate, an oxazoline, an oxazolinium, an oxazine, an oxazinium, a pyridyl thio, and a thiosulfate group.

31. The system of claim 1, said first formulation having a concentration of said polycation of at least about 0.01% (w/v), and said second formulation having a concentration of said polymer of at least about 0.01% (w/v).

32. The system of claim 1, said first formulation having a concentration of said polycation of from about 0.01% (w/v) to about 0.5% (w/v), and said second formulation having a concentration of said polymer of from about 0.01% (w/v) to about 0.5% (w/v).

33. A hair hold system, said system comprising:
(a) a first formulation comprising a polycation; and
(b) a second formulation comprising a polymer capable of at least one of:
(i) forming a complex with said polycation; and
(ii) forming a covalent bond with said polycation,
wherein said first formulation and said second formulation are kept separate before application to hair.

34. The hair hold system of claim 33, further comprising a container for said first and said second formulations, said container comprising at least two chambers, said chambers separating said first and said second formulations.

35. The hair hold system of claim 34, wherein said container is configured to allow separate application of said first and said second formulations to hair.

36. The hair hold system of claim 34, wherein said container is configured to allow simultaneous application of said first and said second formulations to hair.

37. A hair hold formulation comprising an emulsion of a hydrophobic macromer in an aqueous solution, said aqueous solution comprising a polycation, wherein said emulsion is substantially stable for at least one hour at ambient conditions without addition of an emulsifying agent other than said polycation.

38. The formulation of claim 37, wherein said polycation comprises an amine and wherein said hydrophobic macromer comprises a functional group capable of reaction with said amine.

39. The formulation of claim 38, wherein said functional group at least initially is substantially non-reactive with said amine in said formulation, and wherein said functional group is capable of reacting with said amine upon drying, upon heating, or upon drying and heating of said formulation following application of said formulation to hair.

40. The formulation of claim 39, wherein said functional group comprises at least one member selected from the following: an epoxy, an anhydride, an acid chloride, an ethylenimino, an aldehyde, a hemiacetal, a hemiaminal, a ketone, an alpha-halo ketone, an alpha-hydroxy ketone, a lactone, a thiolactone, an isocyanate, a thiocyanate, an N-hydroxy succinimide ester, an imide, an imine, an imidate, an oxazoline, an oxazolinium, an oxazine, an oxazinium, a pyridyl thio, and a thiosulfate group.

41. The formulation of claim 37, wherein said hydrophobic macromer is capable of hydrostatic interaction with said polycation.

42. The formulation of claim 41, wherein said hydrophobic macromer demonstrates enhanced hydrostatic interaction with said polycation upon drying, upon heating, or upon drying and heating of said emulsion following application of said formulation to hair.

43. The formulation of claim 41, wherein said hydrophobic macromer comprises at least one member selected from the following: a sulfuric acid group, a phosphoric acid group, and a carboxylic acid group.

44. The formulation of claim 37, wherein said hydrophobic macromer has a glass transition temperature below about 25° C.

45. The formulation of claim 37, wherein said hydrophobic macromer comprises a reactive silicone.

46. The formulation of claim 45, wherein said reactive silicone comprises at least one member selected from the following: an amino-modified silicone, an epoxy-modified silicone, a carboxyl-modified silicone, a carbinol-modified silicone, a methacryl-modified silicone, a phenol-modified silicone, a polyether-modified silicone, and a mercapto-modified silicone.

47. The formulation of claim 37, wherein said hydrophobic macromer comprises an elastomer.

48. The formulation of claim 47, wherein said elastomer comprises at least one of polybutadiene and polyisoprene.

49. The formulation of claim 47, wherein said elastomer comprises polybutadiene having one or more functional groups capable of reaction with said polycation.

50. The formulation of claim 47, wherein said elastomer comprises polybutadiene having one or more functional groups capable of reaction with an amine of said polycation.

51. The formulation of claim 37, wherein said emulsion is substantially stable for at least one month at ambient conditions without addition of an emulsifying agent other than said polycation.

52. The formulation of claim 37, wherein said emulsion is substantially stable for at least one hour at ambient conditions without addition of a surfactant.

53. The formulation of claim 37, wherein said polycation comprises at least one member selected from the following: polyethylenimine, polyvinylamine, polyallylamine, chitosan, a cationic cellulose derivative, and a cationic starch derivative.

54. The formulation of claim 53, wherein said polycation comprises linear polyethylenimine.

55. The formulation of claim 54, wherein said linear polyethylenimine is substituted.

56. The formulation of claim 53, wherein said polycation comprises chitosan.

57. The formulation of claim 37, wherein said formulation comprises an additive.

58. The formulation of claim 57, wherein said additive is a cosmetic additive.

59. The formulation of claim 57, wherein said additive comprises at least one member selected from the following: a UV blocker, a fragrance, a pheromone, a color, a polymeric dye, a conditioner, a thickener, an insect repellent, a preservative, an acid, a base, a salt, a pH adjusting agent, a charge density adjusting agent, a solubility enhancing agent, a deposition aid, and a dispersing agent.

60. The formulation of claim 57, wherein said additive comprises a pH adjusting agent, said pH adjusting agent comprising an acid, a base, a salt, or any combination thereof.

61. The formulation of claim 57, wherein said additive comprises a solubility enhancing agent, said solubility enhancing agent comprising water, an alcohol, another solvent, or any combination thereof.

62. The formulation of claim 57, wherein said additive comprises a solubility enhancing agent, said solubility enhancing agent comprising a liquid in which said hydrophobic macromer is substantially insoluble.

63. The formulation of claim 57, wherein said additive comprises a solubility enhancing agent, wherein said solubility enhancing agent enhances the solubility of one or more components of said formulation.

64. The formulation of claim 57, wherein said additive comprises a charge density adjusting agent, said charge density adjusting agent comprising an acid, a base, a salt, or any combination thereof.

65. The formulation of claim 37, wherein at least one of said polycation and said hydrophobic macromer comprises at least one functional group providing at least one of the following: a fragrance, a color, and a UV blocker.

66. The formulation of claim 37, said formulation having a combined concentration of said hydrophobic macromer and said polycation of at least about 0.1% (w/v).

67. The formulation of claim 37, said formulation having a combined concentration of said hydrophobic macromer and said polycation of from about 0.1% (w/v) to about 10% (w/v).

68. The formulation of claim 37, said formulation having a weight ratio of said polycation to said hydrophobic macromer from about 1:0.5 to about 1:12.

69. The formulation of claim 37, said formulation having a weight ratio of said polycation to said hydrophobic macromer from about 1:3 to about 1:6.

70. The formulation of claim 37, wherein relative amounts of said hydrophobic macromer and said polycation are adjusted according to how said formulation is applied to hair.

71. The formulation of claim 37, said formulation having a weight ratio of said polycation to said hydrophobic macromer is about 1:1.

72. The formulation of claim 37, said formulation having a chitosan concentration of at least about 0.3%.
